(19) United States
(12) Patent Application Publication
(10) Pub. No.: US 2008/0092402 A1
(43) Pub. Date: Apr. 24, 2008

(54) Multi-functional measuring tape and laser tool

(76) Inventor: Jing Rong Ye, Zhejiang (CN)

Correspondence Address: Raymond Y. Chan, Suite 128, 108 N. Ynez Avenue, Monterey Park, CA, 91754, US

(21) Appl. No.: 11/974,496

(22) Filed: Oct. 12, 2007

Related U.S. Application Data
(60) Provisional application No. 60/851,409, filed on Oct. 13, 2006.

(51) Int. Cl. G01B 3/10

(52) U.S. Cl. 33/764

(57) ABSTRACT

A multi-functional measuring tape includes a main housing and a bi-directional measuring arrangement. The bidirectional measuring arrangement includes two tape members, and two retraction devices. Each of the tape members has a plurality of measuring marks formed thereon, a retractable portion retractably received in the main housing, and a measuring portion aligned with the corresponding tape opening of the main housing, and adapted to be extended out of the main housing via the corresponding tape opening for measuring a distance between two points along the corresponding tape member as indicated by the measuring marks. Each of the retracting devices is received within the main housing to retractably couple with the first and the second tape member respectively for allowing the first and the second tape member to operate between an idle mode and a measurement mode.

### BACKGROUND OF THE PRESENT INVENTION

1. Field of Invention

The present invention relates to a measuring tape, and more particularly to a multi-functional measuring tape with laser tool which is capable of measuring distance in two opposite directions at the same time.

2. Description of Related Arts

A conventional measuring tape usually comprises a main housing having a receiving cavity and an opening, an elongated tape member, having a plurality of measuring marks printed thereon, retractably received within the receiving cavity, and a coil retraction arrangement provided in the receiving cavity for coupling with a retracting portion of the tape member, in such a manner that the tape member is normally received within the main housing for easy carriage and storage, and when measurement is needed, the tape member can be retractably pulled out from the receiving cavity via the opening for measuring a distance between predetermined points of the tape member with the aid of the measuring marks. Once the measurement is completed, the tape member is automatically retracted by the coil retraction arrangement so as to maintain a compact structure of the conventional measuring tape.

There are several disadvantages with this kind of conventional measuring tape. First, the conventional measuring tape can only measure distance in one direction for each single measurement exercise. Thus, when one needs to measure distance in two directions, he or she has to perform the measurement twice (i.e. perform the measurement in two different directions separately). Alternatively, when a user needs to measure distance in two directions, he may ask another person to help him so that the two distances can be measured at the same time. However, when such a strategy is used, they have to use two separate measuring tapes for performing two different measurements in two different directions at the same time. Very often, this is time-consuming and a waste of resources. Moreover, when two or more measuring tapes are utilized for measuring distances in several directions (say, in two opposite directions), it is relatively easy make serious measurement errors.

Moreover, when one wishes to measure the mid-point of two measuring points, the conventional method is to measure the entire distance of those two measuring points, and then manually divide the measured distance by two so as to get the distance from the either measuring point to the mid point of the entire distance. This is inconvenient when one takes into account that the user may not have the necessary calculator or he needs the mid point rapidly (i.e. when there is no time for calculation).

Another disadvantage for conventional in-situ measuring practice is that the technician may need to carry many accessories (e.g. a measuring tape, stationeries, stud sensors etc.) for a fairly long distance. As a result, they may either need to put all the equipments into a bag, or carry every item by hands. However, in many occasions, they may not wish to carry a bag with them.

### SUMMARY OF THE PRESENT INVENTION

A main object of the present invention is to provide a multi-functional measuring tape with laser tool which is capable of measuring distance in two opposite directions at the same time.

Another object of the present invention is to provide a multi-functional measuring tape which comprises a bi-directional measuring arrangement, which is adapted to retractably extend two opposite tape members in two opposite directions for measuring distance in those two opposite directions simultaneously.

Another object of the present invention is to provide a multi-functional measuring tape which comprises a bi-directional measuring arrangement, wherein the multi-functional measuring tape is adapted for incorporating a wide variety of auxiliary devices, such as a laser tool, for enhancing the quality of measurement exercise.

Another object of the present invention is to provide a multi-functional measuring tape which is easy to use, compact in size, and can be utilized in a wide variety of circumstances.

Accordingly, in order to accomplish the above objects, the present invention provides a multi-functional measuring tape, comprising:

a main housing having a receiving cavity, and two opposite tape openings formed on the main housing and communicating the receiving cavity with an exterior of the main housing; and

a bidirectional measuring arrangement, which comprises:

a first and a second tape member each of which has a plurality of measuring marks formed thereon, a retractable portion retractably received in the main housing, and a measuring portion aligned with the corresponding tape opening of the main housing, and adapted to be extended out of the main housing via the corresponding tape opening for measuring a distance between two points along the corresponding tape member as indicated by the measuring marks; and

a first and a second retracting devices received within the main housing to retractably couple with the first and the second tape member respectively for allowing the first and the second tape member to operate between an idle mode and a measurement mode, wherein in the idle mode, the first and the second tape member are respectively retracted by the first and the second retracting devices to receive in the receiving cavity, wherein in the measurement mode, the first and the second tape members are extended out of the main housing in two opposite directions via the two tape openings respectively for measuring distance in a bidirectional manner from the main housing.

These and other objectives, features, and advantages of the present invention will become apparent from the following detailed description, the accompanying drawings, and the appended claims.

### BRIEF DESCRIPTION OF THE DRAWINGS

FIG. 1 is a sectional side view of a multi-functional measuring tape according to a preferred embodiment of the present invention.

FIG. 2 is a perspective view of the multi-functional measuring tape according to the above preferred embodiment of the present invention.

FIG. 3 is a schematic diagram of the multi-functional measuring tape according to the above preferred embodiment of the present invention.

FIG. 4A to FIG. 4C are schematic diagrams of the multi-functional measuring tape according to the above preferred embodiment of the present invention, illustrating the different spatial distributions of the tape members.

### DETAILED DESCRIPTION OF THE PREFERRED EMBODIMENT

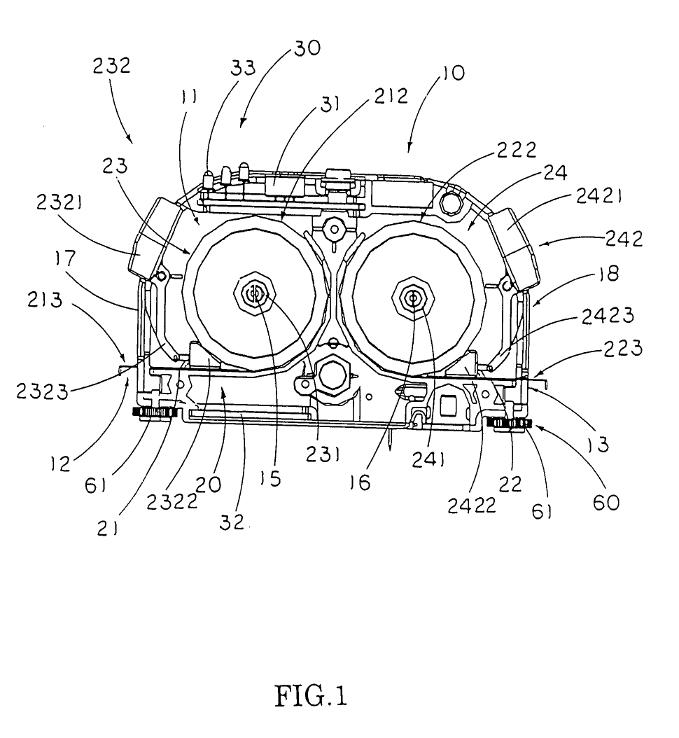

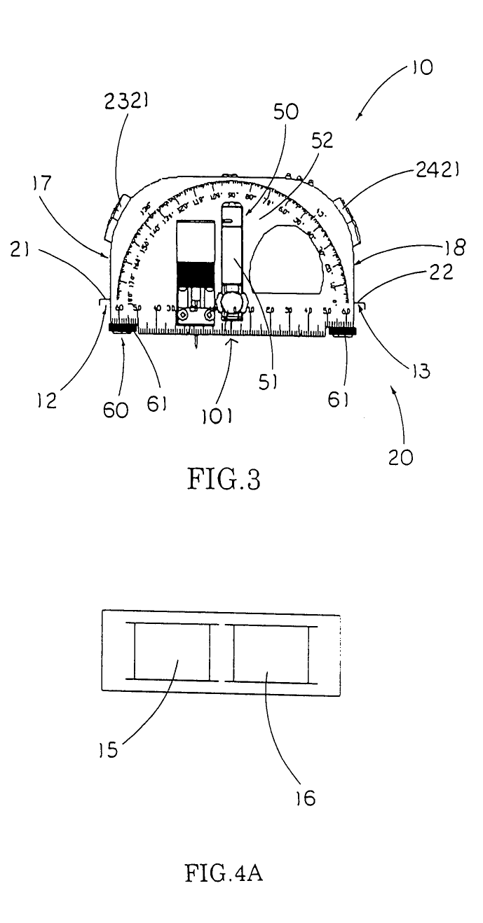

Referring to FIG. 1 to FIG. 3 of the drawings, a multi-functional measuring tape according to a preferred embodiment of the present invention is illustrated, in which the multi-functional measuring tape comprises a main housing 10, and a bi-directional measuring arrangement 20.

The main housing 10 has a receiving cavity 11, and first and second opposite tape openings 12, 13 formed on a first and a second opposed measurement sides 17, 18 of the main housing 10 respectively, and communicating the receiving cavity 11 with an exterior of the main housing 10.

The bidirectional measuring arrangement 20 comprises a first and a second tape member 21, 22, and a first and a second retracting device 23, 24. The first tape member 21 has a plurality of first measuring marks 211 formed thereon, a first retractable portion 212 retractably received in the main housing 10, and a first measuring portion 213 aligned with the first tape opening 12 of the main housing 10, and adapted to be extended out of the main housing 10 via the first tape opening 12 for measuring a distance between two points along the first tape member 21 as indicated by the first measuring marks 211.

On the other hand, the second tape member 22 has a plurality of second measuring marks 221 formed thereon, a second retractable portion 222 retractably received in the main housing 10, and a second measuring portion 223 aligned with the second tape opening 13 of the main housing 10, and adapted to be extended out of the main housing 10 via the second tape opening 13 for measuring a distance between two points along the second tape member 22 as indicated by the second measuring marks 221.

The first and a second retracting devices 23, 24 are received within the main housing 10 to retractably couple with the first and the second tape member 21, 22 respectively for allowing the first and the second tape member 21, 22 to operate between an idle mode and a measurement mode, wherein in the idle mode, the first and the second tape member 21, 22 are respectively retracted by the first and the second retracting devices 23, 24 to receive in the receiving cavity 11, wherein in the measurement mode, the first and the second tape members 21, 22 are extended out of the main housing 10 in two opposite directions via the two tape openings 12, 13 respectively for accurately measuring distance in a bi-directional manner from the main housing 10.

According to the preferred embodiment of the present invention, the main housing 10 has a polygonal cross section for normally forming a compact size of the multi-functional measuring tape when the first and the second tape member 21, 22 are in the idle mode, wherein the first and the second tape openings 12, 13 are formed at two lower corner portions of the main housing 10 for allowing the first and the second tape members 21, 22 to be extended out from the first and the second tape openings 12, 13 respectively. Moreover, the main housing 10 further comprises a first and a second coil connector 15, 16 provided with in the receiving cavity 11 for operatively coupling with the first and the second tape member 21, 22 in a retractably extendable manner at two opposite directions. Accordingly, the first and the second retracting devices 23, 24 are coupled with the first and the second coil connectors 15, 16 for selectively retracting the first and the second tape member 21, 22 respectively.

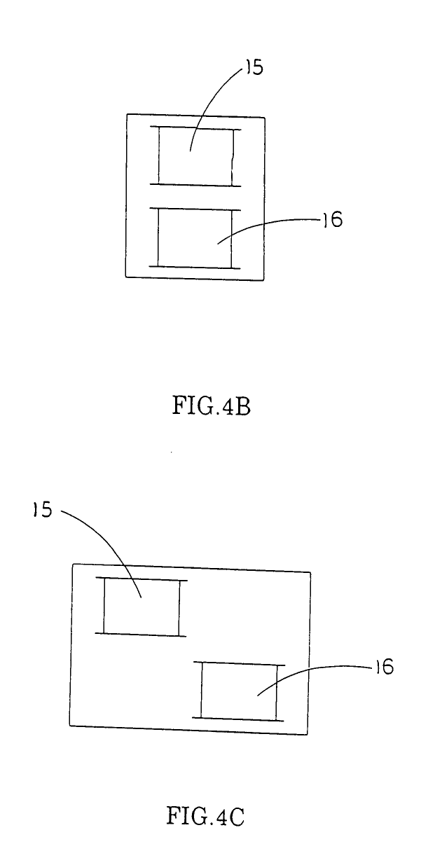

It is worth mentioning that the spatial distribution of the first and the second coil connectors 15, 16 can take a number of different forms within the receiving cavity 11 of the main housing 10. Referring to FIG. 4A of the drawings, the first and the second connector 15, 16 are provided in the receiving cavity in a side-by-side manner along a longitudinal direction of the main housing 10. Referring to FIG. 4B of the drawings, the first and the second connector 15, 16 are provided in the receiving cavity in a side-by-side manner along a vertical direction of the main housing 10. Referring to FIG. 4C of the drawings, the first and the second connector 15, 16 are provided in the receiving cavity diagonally.

Each of the first and the second tape member 21, 22 is elongated in shape and is shaped and crafted to have a physical structure having a predetermined flexibility and ductility, such as metal sheets, so that the first and the second tape member 21, 22 are extendable from the main housing 10 for measurement and retractable by the first and the second retracting devices 23, 24.

The first retracting device 23 comprises a first resilient coil 231 coupling between the first coil connector 15 and an inner end portion of the first tape member 21 for normally exerting a radial retracting force thereto for normally retracting the first tape member 21 about the first coil connector 15. Referring to FIG. 1 of the drawings, the first coil connector 15 comprises a first supporting axle protruded from within the receiving cavity 11, wherein the first resilient coil 231 of the first retracting device 23 is mounted on the first coil connector 15 for coupling with the first tape member 21.

Similarly, the second retracting device 24 comprises a second resilient coil 241 coupling between the second coil connector 16 and an inner end portion of the second tape member 22 for normally exerting a radial retracting force thereto for normally retracting the second tape member 22 about the second coil connector 16. As shown in FIG. 1 of the drawings, the second coil connector 16 comprises a second supporting axle protruded from within the receiving cavity 11, wherein the second resilient coil 241 of the second retracting device 24 is mounted on the second coil connector 16 for coupling with the second tape member 22.

Referring to FIG. 1 of the drawings, the first retracting device 23 further comprises a first retraction actuating arrangement 232 provided on the first measurement side of the main housing 10 for normally selectively locking the retraction of the first tape member 21, and automatically retracting the first tape member 21 when the first retraction actuating arrangement 232 is actuated. More specifically, the first retraction actuating arrangement 232 comprises a first retraction button 2321 operatively mounted on a first measurement side 17 of the main housing 10, a first retraction stopper 2322 provided in the receiving cavity 11 and detachably engaged with an outer side surface of the outermost layer of the first tape member 21, and a first resilient element 2323 mounted between the first retraction stopper 2322 and the first retraction button 2321 in such a manner that the first resilient element 2323 is adapted to normally apply an urging force towards the first retraction stopper 2322 for pushing it towards the outer side surface of the outermost layer of the first tape member 21 so as to stop retraction or further extension thereof. When the first and the second tape member 21, 22 are in the operation mode, the first tape member 21 is biased by the first retraction stopper 2322 so as to stop further moving. When the user wishes to retract the first tape member 21, he or she has to push the first retraction button 2321 so as to disengage the first retraction stopper 2322 from the first tape member 21 for releasing the normal urging force exerted thereto. Accordingly, the first tape member 21 is arranged to be automatically retracted by the first resilient coil 231.

Similarly, the second retracting device 24 further comprises a second retraction actuating arrangement 242 provided on the second measurement side of the main housing 10 for normally selectively locking the retraction of the second tape member 22, and automatically retracting the second tape member 22 when the second retraction actuating arrangement 242 is actuated. More specifically, the second retraction actuating arrangement 242 comprises a second retraction button 2421 operatively mounted on a second measurement side 18 of the main housing 10, a second retraction stopper 2422 provided in the receiving cavity 11 and detachably engaged with an outer side surface of the outermost layer of the second tape member 22, and a second resilient element 2423 mounted between the second retraction stopper 2422 and the second retraction button 2421 in such a manner that the second resilient element 2423 is adapted to normally apply an urging force towards the second retraction stopper 2422 for pushing it towards the outer side surface of the outermost layer of the second tape member 22 so as to stop retraction or further extension thereof. When the first and the second tape member 21, 22 are in the operation mode, the second tape member 22 is pushed by the second retraction stopper 2422 so as to stop further moving. When the user wishes to retract the second tape member 22, he or she has to push the second retraction button 2421 so as to disengage the second retraction stopper 2422 from the second tape member 22 for releasing the normal urging force exerted thereto. Accordingly, the second tape member 22 is arranged to be automatically retracted by the second resilient coil 241.

The multi-functional measuring tape further comprises a metal detector 30 provided on the main housing 10 for searching metallic materials, such as nails, which are located underneath the main housing 10. The metal detector 30 comprises a detection circuitry 31 mounted within the main housing 10, a metal sensor 32 provided on the bottom surface of the main housing 10 and is electrically connected with the detection circuitry 31, and a metal indicator 33 provided on the main housing 10 and is also electrically connected with the detection circuitry 31. The metal sensor 32 is adapted to transmit a detection signal to the surface on which the main housing 10 is located or the a measurement is to be done, and when a metallic object is detected, the metal sensor 32 will transmit an actuation signal to the detection circuitry 31 which then activates the metal indicator 33 for notifying a user that a metallic object has been detected. As a result, a user of the present invention is able to locate two points of metallic objects for carrying out further measurement or other engineering procedures.

Moreover, the multi-functional measuring tape of the present invention further comprises a horizontal indicator 40 provided on the main housing 10 for indicating a horizontal orientation of the main housing 10, and a laser device 50 comprising a laser emitter 51 mounted on the main housing 10 in a rotatably adjustable manner for generating laser beam in predetermined direction as required by the user. Moreover, the laser device 50 further comprises an angle indicator 52 mounted on the main housing for indicating an angle of projection of the laser emitter 51 so as to allow the user to perform precise calculation as to the distance between a reference point in the main housing 10 and a laser point generated by the laser emitter 51. With the aid of the laser beam, the angle indicator 52 and simple geometry, the user is able to perform measurement in a wide variety of different circumstances.

It is important to stress at this stage that the multi-functional measuring tape is extremely suitable to locate the mid-point of two different measuring points without needing to perform manual calculation, as stated above. Specifically, when one needs to measure the mid point of two different measuring points, he or she needs only to put or mount the main housing 10 in an approximate reference point. After that, he or she needs to extend the first and the second tape members 21, 22 from the main housing 10 to the two measuring points respectively. Then, the user may slightly adjust the position of the main housing 10 such that the readings on the first and the second tape members 21, 22 are the same. When this occurs, it means that a mid-point of the main housing 10 is the mid-point of the two measuring points. In order to further assist locating of mid-points, the main housing 10 further has a mid-point reference mark 101 formed thereon for indicating a mid-point of the main housing 10. Thus, the mid-point of the two measuring points coincides with the mid-point reference mark 101 when the two tape members 21, 22 are extended to the two measuring points and have the same reading.

Referring to FIG. 1 to FIG. 3 of the drawings, the multi-functional measuring tape further comprises a mounting device 60 provided on the main housing 10 for mounted onto a flat surface. Thus, the mounting device 60 comprises a plurality of mounting members 61 downwardly extended from the main housing 10 for mounting onto the flat surface so as to securely mount the multi-functional measuring tape onto a predetermined object for conveniently carrying out a measurement exercise.

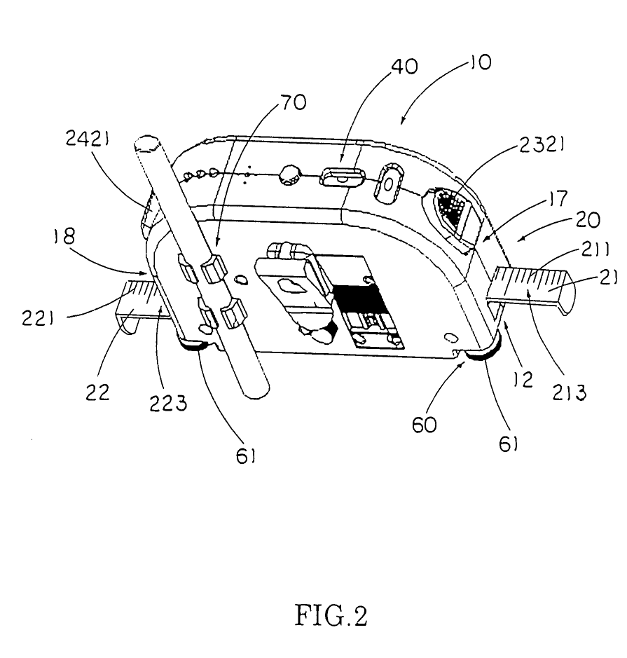

Finally, referring to FIG. 2 of the drawing, the multi-functional measuring tape further comprises an accessories mount 70 provided on the main housing 10 for containing accessories which may be required in a typical measurement process. The accessories mount 70 may be embodied as two mounting clips provided on the main housing 10 for clipping a pencil so as to allow convenient access to writing instrument during a typical measuring process.

Finally, it is worth mentioning that the main housing 10 further comprises two leg frames 19 provided on the main housing 10 for slightly adjusting an orientation thereof.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A multi-functional measuring tape, comprising:
a main housing having a receiving cavity, and two opposite tape openings formed on the main housing and communicating the receiving cavity with an exterior of the main housing; and
a bi-directional measuring arrangement, which comprises:
a first and a second tape member each of which has a plurality of measuring marks formed thereon, a retractable portion retractably received in the main housing, and a measuring portion aligned with the corresponding tape opening of the main housing, and adapted to be extended out of the main housing via the corresponding tape opening for measuring a distance between two points along the corresponding tape member as indicated by the measuring marks; and
a first and a second retracting devices received within the main housing to retractably couple with the first and the second tape member respectively for allowing the first and the second tape member to operate between an idle mode and a measurement mode, wherein in the idle mode, the first and the second tape member are respectively retracted by the first and the second retracting devices to receive in the receiving cavity, wherein in the measurement mode, the first and the second tape members are extended out of the main housing in two opposite directions via the two tape openings respectively for measuring distance in a bi-directional manner from the main housing.
